(19) United States
(12) Patent Application Publication
(10) Pub. No.: US 2008/0251742 A1
(43) Pub. Date: Oct. 16, 2008

(54) Pressure Control Valve

(76) Inventors: Sadatake Ise, Tokyo (JP); Shu Yanagisawa, Tokyo (JP); Masaki Tomaru, Tokyo (JP); Toshiharu Katayama, Tokyo (JP)

Correspondence Address: REED SMITH LLP, 3110 FAIRVIEW PARK DRIVE, SUITE 1400, FALLS CHURCH, VA, 22042, US

(21) Appl. No.: 11/884,863

(22) PCT Filed: Feb. 24, 2006
(86) PCT No.: PCT/JP2006/303393

§ 371 Date: Aug. 22, 2007

(30) Foreign Application Priority Data
Feb. 24, 2005 (JP) 2005-049580

(51) Int. Cl. F16K 31/00; F16K 31/126; F25B 41/00; F25B 41/04

(52) U.S. Cl. 251/11; 251/61.1; 62/513; 62/222

(57) ABSTRACT

There is disclosed a pressure control valve comprising: a valve body (10A) provided successively with, mentioning from the upstream side in the flowing direction of refrigerant, a refrigerant inflow port (11), a refrigerant introduction chamber (14), a valve seat (13) with which a rod-like valve (15) is retractably contacted, and a refrigerant outflow port (12); and a temperature-sensitive/pressure-responsive element (20) which is provided with a temperature sensitive chamber (25) for sensing the temperature of the refrigerant that has been introduced into the refrigerant introduction chamber (14) and is designed to drive the valve (15) in opening or closing direction in response to fluctuations of the inner pressure of the temperature sensitive chamber (25). The temperature-sensitive/pressure-responsive element (20) is integrally attached to the valve body (10A).

### TECHNICAL FIELD

This invention relates to a pressure control valve which is suited for use in a vapor compression refrigeration cycle using CO₂ as a refrigerant (CO₂ cycle) or especially suited for use in a vapor compression refrigeration cycle provided with an inner heat exchanger which is designed to be employed in an automobile air conditioner for performing heat exchange between the refrigerant on the exit side of an evaporator and the refrigerant on the exit side of a gas cooler.

### BACKGROUND ART

FIG. 19 shows one example of the vapor compression refrigeration cycle wherein a pressure control valve of this kind is built therein. The refrigeration cycle 100 shown herein is constituted: by a compressor 101 for circulating CO₂ as a refrigerant; a gas cooler (radiator) 102 for cooling the refrigerant that has been compressed by the compressor 101; an evaporator 104 into which the refrigerant is enabled to enter from the gas cooler 102; an inner heat exchanger 103 for performing heat exchange between the refrigerant on the exit side of the evaporator 104 and the refrigerant on the exit side of the gas cooler 102; an accumulator (vapor-liquid separator) 105 for separating the refrigerant from the evaporator 104 into a vapor-phase refrigerant and a liquid-phase refrigerant to thereby introduce the vapor-phase refrigerant into the inlet side of the compressor 101 through the inner heat exchanger 103, a redundant portion of the refrigerant being accumulated in the accumulator 105; and a pressure control valve 110 for regulating the pressure of the refrigerant which has been introduced therein, via the inner heat exchanger 103, from the gas cooler 102 in conformity with the temperature of the refrigerant on the exit side of the gas cooler 102, the refrigerant thus regulated in pressure being transferred therefrom to the evaporator 104.

This pressure control valve 110 is provided so as to effectively operate the refrigeration cycle 100. In other words, this pressure control valve 110 is provided to regulate the pressure of the refrigerant on the exit side of gas cooler 102 so as to obtain a maximum coefficient of performance relative to the temperature of the refrigerant on the exit side of gas cooler 102 (for example, if it is admitted that a maximum coefficient of performance can be obtained when the pressure of the refrigerant on the exit side of gas cooler is regulated to 10 MPa as the temperature of the refrigerant on the exit side of gas cooler is 40° C., the pressure control valve 110 is controlled in such a manner that the pressure of the refrigerant on the exit side of gas cooler would become 10 MPa). For example, as described in JP Patent Laid-open Publication (Kokai) No. 2000-81157, the pressure control valve 110 comprises: a pressure-regulating inflow port 111 for introducing the refrigerant from the gas cooler 102 through the inner heat exchanger 103; a pressure-regulating outflow port 112 for delivering the refrigerant to the evaporator 104 after regulating the pressure of refrigerant in conformity with the temperature of the refrigerant on the exit side of the gas cooler 102; a temperature-sensing inflow port 113 for introducing the refrigerant from the gas cooler 102; a temperature-sensing outflow port 114 for delivering the refrigerant to the inner heat exchanger 103; a refrigerant introduction chamber (not shown) interposed between the temperature-sensing inflow port 113 and the temperature-sensing outflow port 114; a temperature-sensitive/pressure-responsive element (not shown) which is provided with a temperature sensitive chamber for sensing the temperature of the refrigerant that has been introduced into the refrigerant introduction chamber and is designed to drive a valve in opening or closing direction in response to fluctuations of the inner pressure of the temperature sensitive chamber; a valve body (the entire body of the control valve shown therein) housing the temperature-sensitive/pressure-responsive element; and a spring member disposed in the valve body for urging the valve body in the direction to minimizing the opening degree thereof (valve-closing direction), wherein the opening degree of valve (magnitude of lifting of the valve body) is designed to be determined according to the balance between the valve-opening force to be effected by a pressure difference between the inside and the outside of the temperature sensitive chamber and the valve-closing force to be effected by the spring member.

### DISCLOSURE OF INVENTION

Even in the pressure control valve constructed as described above as well as in the refrigeration cycle provided with such a pressure control valve, there are increasing and persistent demands in recent years for the reduction of manufacturing cost, so that it is now strongly desired to simplify the structure thereof, to reduce the number of parts, and to reduce the processing and assembling costs.

In the case of the refrigeration cycle provided with the conventional pressure control valve in particular, the pressure control valve is interposed between the gas cooler and the inner heat exchanger, so that the refrigerant on the exit side of the gas cooler is enabled to be directly introduced into the pressure control valve, enabling the temperature of the refrigerant to be sensed by the temperature-sensitive/pressure-responsive element, and then the refrigerant is delivered to the inner heat exchanger to execute the heat exchange thereof and, after this heat exchange, returned again to the pressure control valve so as to be regulated in pressure, this pressure-regulated refrigerant being subsequently delivered to an evaporator. Therefore, the pressure control valve is required to be equipped with a total of four refrigerant inlet and outlet ports, i.e. a temperature-sensing inlet port, a temperature-sensing outlet port, a pressure-regulating inlet port and a pressure-regulating outlet port. As a result, the piping system for the pressure control valve as well as for the refrigeration cycle is complicated in construction, thus making it difficult to reduce the cost for assembling the system as a whole.

The present invention has been made to meet the aforementioned demands, and therefore an object of the present invention is to provide a pressure control valve which is capable of appropriately regulating the pressure of the refrigerant on the exit side of the gas cooler and also capable of effectively simplifying the structure thereof, reducing the number of parts and reducing the processing and assembling costs. A further object of the present invention is to provide a refrigeration cycle comprising such a pressure control valve.

With a view to achieve the aforementioned objects, there is provided, according to the present invention, a pressure control valve which essentially comprises: a valve body provided successively with, mentioning from the upstream side in the flowing direction of refrigerant, a refrigerant inflow port, a refrigerant introduction chamber, a valve seat with which a rod-like valve is retractably contacted, and a refrigerant outflow port; and a temperature-sensitive/pressure-responsive element which is provided with a temperature sensitive chamber for sensing the temperature of the refrigerant that has been introduced into the refrigerant introduction chamber and is designed to drive a valve in opening or closing direction in response to fluctuations of the inner pressure of the temperature sensitive chamber; wherein the temperature-sensitive/pressure-responsive element is integrally attached to the valve body.

More specifically, there is provided a pressure control valve which is designed to be built in a vapor compression refrigeration cycle which is constituted by: a compressor for circulating CO₂ as a refrigerant; a gas cooler for cooling the refrigerant that has been compressed by the compressor; an evaporator into which the refrigerant is enabled to enter from the gas cooler; and an inner heat exchanger for performing heat exchange between the refrigerant on the exit side of the evaporator and the refrigerant on the exit side of the gas cooler; wherein the pressure control valve comprises: a valve body provided successively with, mentioning from the upstream side in the flowing direction of refrigerant, a refrigerant inflow port, a refrigerant introduction chamber, a valve seat with which a rod-like valve is retractably contacted, and a refrigerant outflow port; and a temperature-sensitive/pressure-responsive element which is integrally attached to the valve body and provided with a temperature sensitive chamber for sensing the temperature of the refrigerant that has been introduced into the refrigerant introduction chamber and is designed to drive a valve in opening or closing direction in response to fluctuations of the inner pressure of the temperature sensitive chamber; wherein the refrigerant that has been introduced via the inner heat exchanger into the pressure control valve from the gas cooler is regulated in pressure in conformity with the temperature of the refrigerant before delivering the refrigerant into the evaporator.

In a preferable embodiment, the temperature sensitive chamber is filled with CO₂ at a predetermined density and with an inert gas to fill up the temperature sensitive chamber in order to regulate the pressure of the refrigerant to be introduced into the pressure control valve from the inner heat exchanger to thereby obtain a maximum coefficient of performance relative to the temperature of the refrigerant on the exit side of gas cooler.

In a further preferable embodiment, the temperature-sensitive/pressure-responsive element is provided with a diaphragm, a cap member having a convex cross-section and defining, in cooperation with the diaphragm, the temperature-sensitive chamber, and a flanged cylindrical cap-receiving member for hermetically holding, in cooperation with the cap member, an outer peripheral portion of the diaphragm while enabling the valve to be fit inside the flange of the cap-receiving member, wherein the cylindrical portion of the flanged cylindrical cap-receiving member is provided with an external thread to be used in attaching the cap-receiving member to the valve body.

In this case, preferably, the valve is disposed coaxial with the diaphragm and an end portion of the valve is bonded to the diaphragm by means of projection welding.

In a further preferable embodiment, the valve is constituted by a cylindrical valve stem and a valve portion provided at a lower end portion of the valve stem, and the valve stem is constituted by a shaft portion and a diametrally enlarged portion which is integrally formed with or secured to an upper end portion of the shaft portion, thereby enabling the diaphragm to be bonded to the upper surface of the diametrally enlarged portion.

In a further preferable embodiment, the valve is provided with an axial hole having an open top, and the diaphragm is provided with an opening for communicating the temperature sensitive chamber with the axial hole, thereby constituting one enlarged temperature sensitive chamber consisting of the temperature sensitive chamber and the axial hole.

In a further preferable embodiment, the valve body is equipped with a vibration-proofing means for suppressing the trembling of the valve.

This vibration-proofing means is preferably constituted either by a vibration-proofing spring formed of a resilient plate and configured to have an annular bottom portion held in place by the valve body, and a plurality of tongue-like flaps rising from the inner periphery of the annular bottom portion and elastically press-contacted with an outer peripheral surface of the valve, or by an O-ring interposed between the valve and the valve body.

In a further preferable embodiment, the pressure control valve is provided with a valve chamber having the valve seat and disposed at a location inside the valve body which is more or less spaced away from the refrigerant introduction chamber, wherein the refrigerant introduction chamber is communicated, through one or plural communicating holes formed in the valve body or in the valve, with the valve chamber.

In a further preferable embodiment, the refrigerant inflow port and the refrigerant outflow port are disposed parallel or orthogonally to each other.

In a further preferable embodiment, a spring for urging the valve to move in a valve-closing direction is disposed in the valve body.

In a further preferable embodiment, the valve seat and/or the valve is provided with a leakage means such as a through-hole, a groove or a notch for enabling the refrigerant that has been introduced into the refrigerant introduction chamber to leak therefrom to the refrigerant outflow port even in a condition where the valve is in a valve-closing state.

In this case, as a specific preferable embodiment, a plurality of bleed notches are radially formed in the valve seat.

In a different preferable embodiment, a plurality of annular grooves are formed on the outer peripherally surface of the valve stem which is located to face the refrigerant introduction chamber.

Meanwhile, the refrigeration cycle according to the present invention is constructed such that the pressure control valve which is constructed as described above is interposed between the inner heat exchanger and the evaporator.

The pressure control valve which is constructed as described above according to the present invention is designed to be interposed between the inner heat exchanger and the evaporator in the refrigeration cycle (according to the prior art, a pressure control valve is interposed between the gas cooler and the inner heat exchanger), wherein the refrigerant on the exit side of the gas cooler is introduced, via the inner heat exchanger, from the refrigerant inflow port into the refrigerant introduction chamber and then the temperature of the refrigerant thus introduced into the refrigerant introduction chamber is detected by the temperature sensitive chamber of the temperature-sensitive/pressure-responsive element. Thereafter, the temperature-sensitive/pressure-responsive element is actuated to drive a valve in opening or closing direction in response to fluctuations of the inner pressure of the temperature sensitive chamber resulting from the detected temperature, thereby regulating the pressure of the refrigerant on the outflow side of the inner heat exchanger.

In this case, the temperature of refrigerant to be introduced into the refrigerant introduction chamber of pressure control valve (the temperature of refrigerant on the exit side of the inner heat exchanger) is correlated with the temperature of refrigerant on the exit side of the gas cooler. However, since the temperature of refrigerant to be introduced into the refrigerant introduction chamber is made lower than the temperature of refrigerant on the exit side of the gas cooler, this temperature drop (pressure drop) is taken into consideration in advance and the temperature sensitive chamber is filled with CO₂ at a predetermined density and with an inert gas to fill up the temperature sensitive chamber in order to regulate the pressure of the refrigerant to be introduced into the pressure control valve from the inner heat exchanger to thereby obtain a maximum coefficient of performance relative to the temperature of the refrigerant on the exit side of gas cooler.

By doing so, it is now possible, though indirectly, to appropriately regulate the pressure of refrigerant on the exit side of the gas cooler in conformity with the temperature of refrigerant on the exit side of the gas cooler. Moreover, according to the pressure control valve of the present invention, the number of inlet/outlet ports of refrigerant is limited to smaller than four as required in the case of the conventional pressure control valve. Namely, one refrigerant inflow port and one refrigerant outflow port, both serving not only as a temperature-sensing member but also as a pressure-sensing member, i.e. a total of two would be enough in the case of the present invention. Therefore, it is now possible to effectively simplify the structure of the piping system, to reduce the number of parts and to reduce the processing and assembling costs for the pressure control valve as well as for the refrigeration cycle.

Additionally, since the temperature-sensitive/pressure-responsive element is enabled to externally mount on the valve body, for example, by means of screwing instead of building it in the valve body, it is now possible to further reduce the manufacturing cost.

Furthermore, since the opening degree of valve can be regulated by making use of only the temperature-sensitive/pressure-responsive element, it is possible to simplify the structure of pressure control valve, to reduce the number of parts and to reduce the manufacturing cost of the pressure control valve as compared with the conventional pressure control valve wherein the opening degree of valve (the magnitude of lifting the valve) is determined based on the balance between the valve-opening force to be effected by a pressure difference between the inside and the outside of the temperature sensitive chamber and the valve-closing force to be effected by the spring member.

The pressure control valve according to another aspect of the present invention fundamentally comprises: a valve body provided successively with a refrigerant inflow port, a refrigerant outflow port, a refrigerant introduction chamber and a valve seat with which a rod-like valve is retractably contacted; and a temperature-sensitive/pressure-responsive element which is integrally attached to the valve body and provided with a temperature sensitive chamber for sensing the temperature of the refrigerant that has been introduced into the refrigerant introduction chamber and is designed to drive a valve in opening or closing direction in response to fluctuations of the inner pressure of the temperature sensitive chamber.

Further, the temperature-sensitive/pressure-responsive element is provided with a diaphragm, and a cap member having a convex cross-section and defining, in cooperation with the diaphragm, the temperature-sensitive chamber, wherein the diaphragm is bonded to an upper end portion of the valve body by means of projection welding.

In this case, as a preferable embodiment, the valve is provided, at a central portion of the top surface thereof, with an annular projection to be used for the aforementioned projection welding.

In a further preferable embodiment, the valve is constituted by a cylindrical valve stem and a valve portion provided at a lower end portion of the valve stem, and the valve stem is constituted by a shaft portion and a diametrally enlarged portion which is integrally formed with or secured to an upper end portion of the shaft portion, wherein the diametrally enlarged portion is provided, at a central portion of the top surface thereof, with an annular projection having a triangular or trapezoidal cross-section, this annular projection being bonded to the diaphragm by means of projection welding.

In a further preferable embodiment, the valve is provided, on an inner peripheral circumference of the annular projection formed on the top surface thereof, with a temperature sensitive contact chamber or axial hole having an open top, and the diaphragm is provided with a communicating hole for enabling the temperature sensitive chamber to communicate with the temperature sensitive contact chamber or with the axial hole.

As described above, since the valve is provided, at an upper end thereof, with the annular projection to thereby enable the valve to directly bond to the diaphragm by means of projection welding, it is now possible to reduce the number of parts and the number of steps, to simplify the assembling process and, at the same time, to realize a sufficient bonding strength as compared with the cases wherein other bonding methods are employed. Further, even in a case wherein the valve is provided with an axial hole having an open top so as to create an enlarged temperature sensitive chamber, it is also possible to secure a sufficient air-tightness.

### BRIEF DESCRIPTION OF DRAWINGS

FIG. 1 is a longitudinal cross-sectional view illustrating a first embodiment of the pressure control valve according to the present invention;

FIG. 2 is a right side view of the pressure control valve shown in FIG. 1;

FIG. 3 is a block diagram illustrating one example of the vapor compression refrigeration cycle having the pressure control valve of the first embodiment of FIG. 1 built therein;

FIG. 4 is a partial enlarged sectional view for explaining the bonding between the diaphragm and the valve in the first embodiment shown in FIG. 1;

FIG. 5 is a partial enlarged sectional view for explaining the vibration-proofing member in the first embodiment shown in FIG. 1;

FIG. 6 is a longitudinal cross-sectional view illustrating a second embodiment of the pressure control valve according to the present invention;

FIG. 7 is a longitudinal cross-sectional view illustrating a third embodiment of the pressure control valve according to the present invention;

FIG. 8 is a longitudinal cross-sectional view illustrating a fourth embodiment of the pressure control valve according to the present invention;

FIG. 9 is a cross-sectional view taken along the X-X of FIG. 8;

FIG. 10 is a longitudinal cross-sectional view illustrating a fifth embodiment of the pressure control valve according to the present invention;

FIG. 11 is a longitudinal cross-sectional view illustrating a sixth embodiment of the pressure control valve according to the present invention;

FIG. 12 is a longitudinal cross-sectional view illustrating a seventh embodiment of the pressure control valve according to the present invention;

FIG. 13 shows a bleed notch formed in the valve seat of the pressure control valve shown in FIG. 12 and the peripheral portion of the bleed notch, wherein (A) shows a cross-sectional view and (B) shows a plan view;

FIG. 14 is a longitudinal cross-sectional view illustrating an eighth embodiment of the pressure control valve according to the present invention;

FIG. 15 is a plan view of the pressure control valve shown in FIG. 14;

FIG. 16 is a left side view of the pressure control valve shown in FIG. 14;

FIG. 17 is a block diagram illustrating one example of the vapor compression refrigeration cycle having the pressure control valve shown in FIG. 14 built therein;

FIG. 18 is a partially sectioned enlarged plan view showing an upper top surface of the valve which is provided with an annular projection in the pressure control valve shown in FIG. 14; and

FIG. 19 is a block diagram illustrating one example of the vapor compression refrigeration cycle having a conventional pressure control valve built therein.

### BEST MODE FOR CARRYING OUT THE INVENTION

Next, various embodiments of the pressure control valve according to the present invention will be explained with reference to drawings.

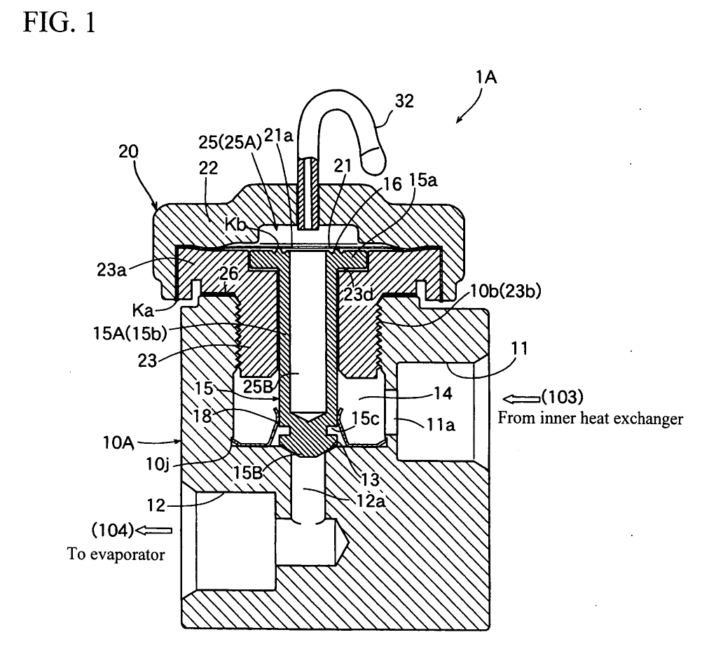

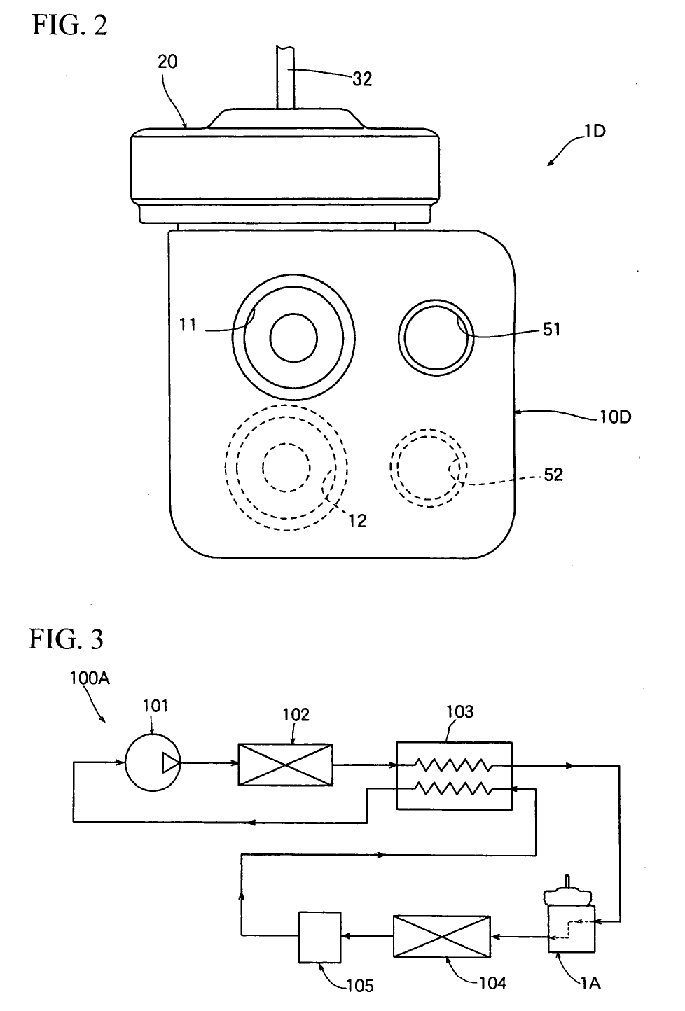

FIGS. 1 and 2 are a longitudinal cross-sectional view and a right side view, respectively, both illustrating a first embodiment of the pressure control valve according to the present invention.

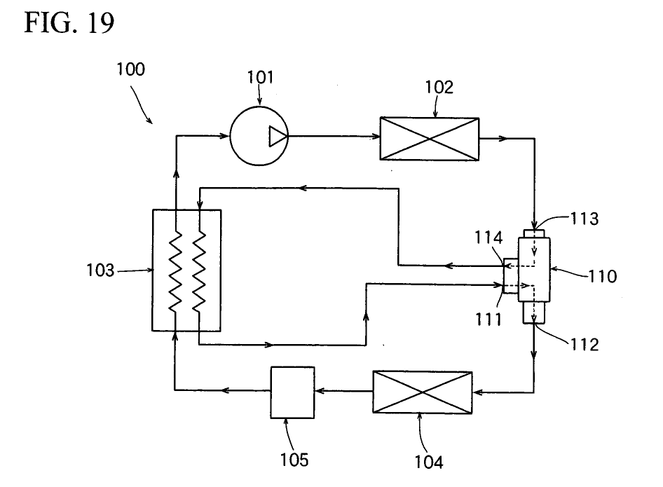

As shown in FIG. 3, the pressure control valve 1A according to a first embodiment is built in a vapor compression refrigeration cycle 100A which is fundamentally constituted by the same constituent elements as those shown in FIG. 19 mentioned above, but in such a different manner from the vapor compression refrigeration cycle shown in FIG. 19 that the pressure control valve 1A is interposed between the inner heat exchanger 103 and the evaporator 104 (in the prior art, the pressure control valve is interposed between the gas cooler 102 and the inner heat exchanger 103).

Therefore, the refrigerant to be introduced into the pressure control valve 1A from the gas cooler 102 through the inner heat exchanger 103 is enabled to be regulated in pressure in conformity with the temperature of refrigerant on the exit side of the gas cooler 102 (or the temperature of refrigerant on the exit side of the inner heat exchanger 103, which is correlated with the temperature of refrigerant on the exit side of the gas cooler 102) before the refrigerant is delivered to the evaporator 104.

By the way, in the vapor compression refrigeration cycle 100A shown in FIG. 3, the same constituent members as those of FIG. 19 are identified by the same reference symbols, thereby omitting the repeating explanation thereof.

The pressure control valve 1A is provided so as to effectively operate the refrigeration cycle 100A. In other words, this pressure control valve 1A is provided to regulate the pressure of the refrigerant on the exit side of gas cooler 102 so as to obtain a maximum coefficient of performance relative to the temperature of the refrigerant on the exit side of gas cooler 102. Therefore, this pressure control valve 1A comprises a valve body 10A, a valve 15 constituted by a valve stem 15A and a conical valve portion 15B (an annular groove 15c is formed on the top surface thereof), and a temperature-sensitive/pressure-responsive element 20.

This valve body 10A is formed from an approximately rectangular parallelepiped body that can be obtained through the cut-out of an aluminum extruded material having a rectangular cross-section, this rectangular parallelepiped body being subsequently subjected to cutting work so as to create various functional portions as described below. Namely, this valve body 10A is provided, at an upper half portion thereof, with a refrigerant inflow port (coupling portion) 11 which opens to right side and includes an inlet passageway 10a for introducing the refrigerant, via the inner heat exchanger 103, from the gas cooler 102; a refrigerant introduction chamber 14 serving also as a valve chamber into which the refrigerant is enabled to introduce from the refrigerant inflow port 11; and a valve seat 13 having a conically recessed surface constituting the bottom of the refrigerant introduction chamber 14 for enabling the valve 15 (or the valve portion 15B thereof) to be retractably contacted therewith. Further, this valve body 10A is provided, at a lower half portion thereof, with a refrigerant outflow port (coupling portion) 12 which opens to the left side and includes an outlet passageway 12a for delivering the refrigerant from the refrigerant introduction chamber 14 to the evaporator 104; and a female thread portion 10b for attaching the temperature-sensitive/pressure-responsive element 20 to this valve body 10A.

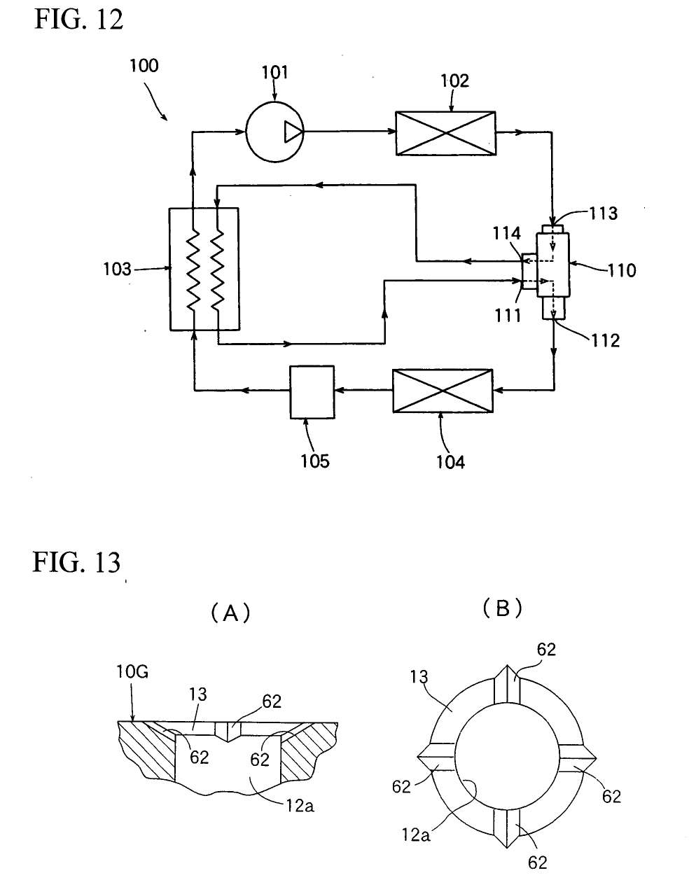

Herein, the refrigerant inflow port 11 and the refrigerant outflow port 12 are disposed parallel with each other and designed to serve also as temperature-sensing inlet/outlet ports and as pressure-regulating inlet/outlet ports in the conventional pressure control valve. By the way, small notches (see FIGS. 12 and 13 illustrating the seventh embodiment to be discussed hereinafter) are formed in the valve seat 13 and the opening degree of the pressure control valve 1A corresponds to the magnitude of lifting of the valve 15 (or the valve portion 15B thereof) from the valve seat 13.

The temperature-sensitive/pressure-responsive element 20 is constituted by a diaphragm 21 having a short cylindrical configuration with a closed end, by a cap member 22 having a convex cross-section and defining, in cooperation with the diaphragm 21, a temperature-sensitive chamber (diaphragm temperature-sensitive chamber) 25A, and by a cylindrical cap-receiving member 23 with a flange portion 23a for holding and hermetically sealing, in cooperation with the cap member 22, the outer peripheral portion (outer peripheral edge and the cylindrical portion) of the diaphragm 21 and, at the same time, for enabling the valve 15 to be slidably fitted therein. The combined portion (nipped portion) of the cap member 22, the cap-receiving member 23 (the flange portion 23a thereof) and a lower end portion of the sandwiched portion (nipped portion) of the diaphragm 21 are bonded to each other by means of welding-all-around (welded portion Ka).

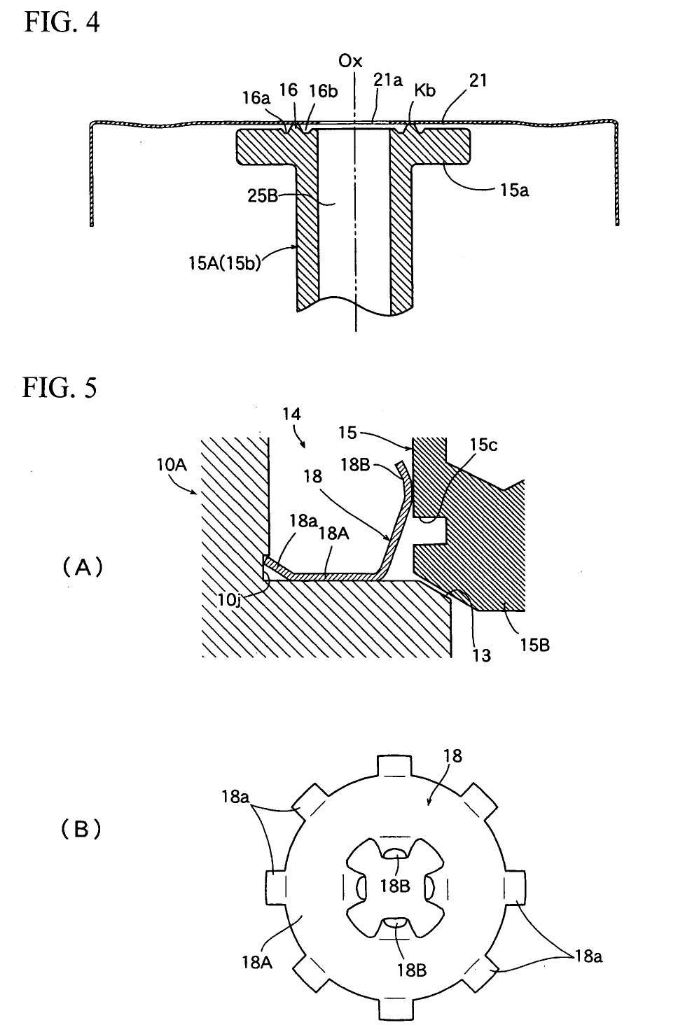

A top portion of the valve stem 15A of valve 15 is formed into a diametrally enlarged portion 15a which is floatably inserted into a recessed portion 23d provided at a top central portion of the cap-receiving member 23, thus enabling the diametrally enlarged portion 15a to move up and down. As shown in FIG. 4, this diametrally enlarged portion 15a is provided, at a top central portion thereof, with an annular projection 16 having a trapezoidal cross-section and also with annular grooves 16a and 16b which are disposed on the inner side and the outer side of the annular projection 16, respectively. The diaphragm 21 is bonded to the annular projection 16 by means of projection welding (welded portion Kb) in such a manner that the diaphragm 21 is disposed coaxial with the valve 15 (a common axial line Ox).

Further, an axial hole (in-valve temperature sensitive chamber 25B) having an open top is provided in the axial portion 15b of the valve 15 (valve stem 15A), and a circular communicating hole 21a for enabling the diaphragm temperature-sensitive chamber 25A to communicate with the in-valve temperature sensitive chamber 25B is formed at a central portion of the diaphragm 21, thereby forming one enlarged temperature sensitive chamber 25 constituted by the diaphragm temperature-sensitive chamber 25A and the in-valve temperature sensitive chamber 25B.

On the other hand, the cap-receiving member 23 is provided, on the outer peripheral wall of cylindrical portion thereof, with a male thread portion 23b to be screw-engaged with the female thread portion 10b, thereby enabling the cap-receiving member 23 to be attached to the valve body 10A. A unit consisting of the temperature-sensitive/pressure-responsive element 20 (the diaphragm 21, the cap member 22 and the cap-receiving member 23) and the valve 15, which are integrally bonded to each other as described above, is enabled to attach to the valve body 10A by entirely rotating it so as to cause the male thread portion 23b to screw-engage with the female thread portion 10b of the valve body 10A. By the way, a gasket 16 is interposed between the underside surface of the cap-receiving member 23 and the top surface of the valve body 10A.

Further, as shown in FIG. 2, for the purpose of attaching the pressure control valve 1A to an appropriate fixing portion (for example, the inner heat exchanger 103 or the evaporator 104), screw holes 51 and 52 are formed on the left and right sidewalls of the valve body 10A, respectively.

Further, a vibration-proofing spring 18 for suppressing the trembling of valve 15 is disposed on the bottom of the refrigerant introduction chamber 14 of valve body 10A. As shown in FIGS. 5(A) and 5(B), this vibration-proofing spring 18 is made of an resilient plate and constituted by a bottom portion 18A having a generally annular configuration (provided with a plurality (eight in this embodiment) of externally extending teeth 18a which are arranged at equiangular intervals) so as to be sustained by the valve body 10A, and a plurality (four in this embodiment) of tongue-like flaps 18B rising from the inner periphery of the bottom portion 18A and elastically press-contacted with the outer peripheral surface of a lower portion of the valve stem 15A of valve 15, these tongue-like flaps 18B being arranged at equiangular intervals (symmetric in back and forth as well as right and left). By the way, the externally extending teeth 18a are bent somewhat upward and engaged with an annular groove 10j formed along the outer periphery of the bottom portion of refrigerant introduction chamber 14. Further, a distal end portion of each of tongue-like flaps 18B is externally bent so as to facilitate the insertion of the valve 15 into the vibration-proofing spring 18.

The pressure control valve 1A constructed as described above according to this embodiment is built in a location between the inner heat exchanger 103 and the evaporator 104 of the vapor compression refrigeration cycle 100A (in the prior art, the pressure control valve is interposed between the gas cooler 102 and the inner heat exchanger 103). Therefore, the refrigerant on the exit side of the gas cooler 102 is introduced, via the inner heat exchanger 103, into the refrigerant introduction chamber 14 from the refrigerant inflow port 11, and the temperature of the refrigerant that has been introduced into the refrigerant introduction chamber 14 is detected by the enlarged temperature sensitive chamber 25 which is constituted by the diaphragm temperature-sensitive chamber 25A and the in-valve temperature sensitive chamber 25B. Then, the temperature-sensitive/pressure-responsive element 20 (the diaphragm 21 thereof) is actuated to drive a valve in opening or closing direction in response to fluctuations of the inner pressure of the temperature sensitive chamber resulting from the detected temperature, thereby regulating the pressure of the refrigerant on the outflow side of the inner heat exchanger 103.

In this case, the temperature of refrigerant to be introduced into the refrigerant introduction chamber 14 of pressure control valve 1A (the temperature of refrigerant on the exit side of the inner heat exchanger 103) is correlated with the temperature of refrigerant on the exit side of the gas cooler 102. However, since the temperature of refrigerant to be introduced into the refrigerant introduction chamber 14 is made lower than the temperature of refrigerant on the exit side of the gas cooler 102, this temperature drop (pressure drop) is taken into consideration in advance and the temperature sensitive chamber 25 is filled with CO₂ at a predetermined density and with an inert gas to fill up the temperature sensitive chamber 25 in order to regulate the pressure of the refrigerant to be introduced into the pressure control valve from the inner heat exchanger 103 to thereby obtain a maximum coefficient of performance relative to the temperature of the refrigerant on the exit side of gas cooler 102.

By doing so, it is now possible, though indirectly, to appropriately regulate the pressure of refrigerant on the exit side of the gas cooler 102 in conformity with the temperature of refrigerant on the exit side of the gas cooler 102. Moreover, according to the pressure control valve 1A of this embodiment, the number of inlet/outlet ports of refrigerant is limited to smaller than four as required in the case of the conventional pressure control valve. Namely, one refrigerant inflow port 11 and one refrigerant outflow port 12, both serving not only as a temperature-sensing member but also as a pressure-sensing member, i.e. a total of two would be enough in this embodiment. Therefore, it is now possible to effectively simplify the structure of the piping system, to reduce the number of parts and to reduce the processing and assembling costs for the pressure control valve as well as for the refrigeration cycle.

Additionally, since the temperature-sensitive/pressure-responsive element 20 is enabled to externally mount on the valve body 10A, for example, by means of screwing instead of building it in the valve body, it is now possible to further simplify the structure of the pressure control valve, to reduce the number of parts and to reduce the processing and assembling costs for the pressure control valve.

Furthermore, since the opening degree of valve can be regulated by making use of only the temperature-sensitive/pressure-responsive element 20, it is possible to simplify the structure of pressure control valve, to reduce the number of parts and to reduce the manufacturing cost of the pressure control valve as compared with the conventional pressure control valve wherein the opening degree of valve (the magnitude of lifting the valve) is determined based on the balance between the valve-opening force to be effected by a pressure difference between the inside and the outside of the temperature sensitive chamber 25 and the valve-closing force to be effected by the spring member.

Next, another embodiment of the pressure control valve according to the present invention will be explained. By the way, in the following description, the members or parts which correspond to those of the pressure control valve 1A of the aforementioned embodiment will be identified by the same reference symbols, thereby omitting the repeating explanation thereof, and the features which differ from the aforementioned embodiment will be emphatically explained

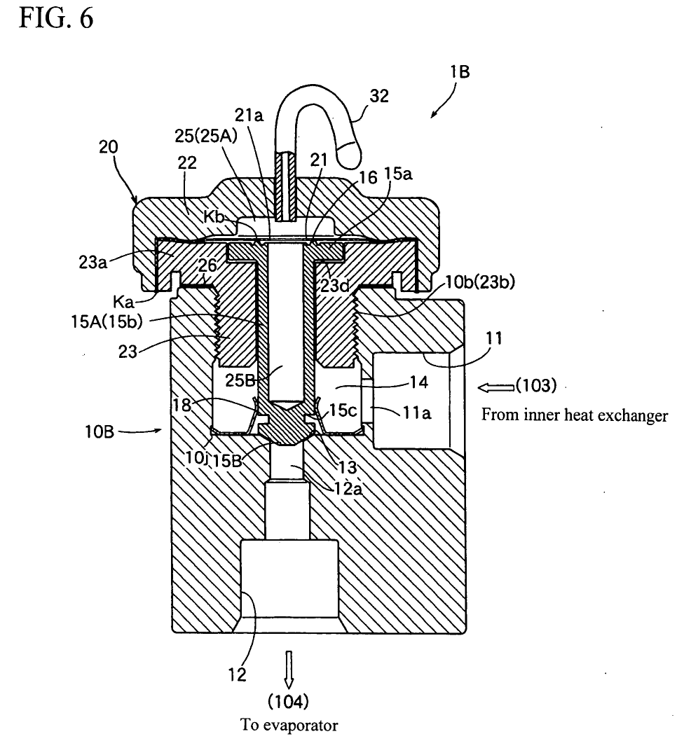

The pressure control valve 1B of a second embodiment shown in FIG. 6 is featured in that it is provided with a refrigerant outflow port 12 which opens downward (in the first embodiment, the refrigerant outflow port 12 opens on the left side thereof). In other words, the refrigerant outflow port 12 is disposed so as to orthogonally intersect with the refrigerant outflow port 11. Other components such as the temperature-sensitive/pressure-responsive element 20, except the valve body 10B, are constructed in the same manner as the pressure control valve 1A of the first embodiment. When these two kinds of pressure control valves 1A and 1B which differ in positional relationship between the refrigerant outflow port 11 and the refrigerant outflow port 12 from one another are prepared in this manner, it is possible to easily arrange the piping by suitably selecting one which is more suited for such an arrangement of piping, thus making it possible to flexibly cope with various kinds of layout. In this case, since all of the components such as the temperature-sensitive/pressure-responsive element 20, except the valve body 10B, can be used in the same manner irrespective of this difference in structure of pressure control valves, it is advantageous in manufacturing cost.

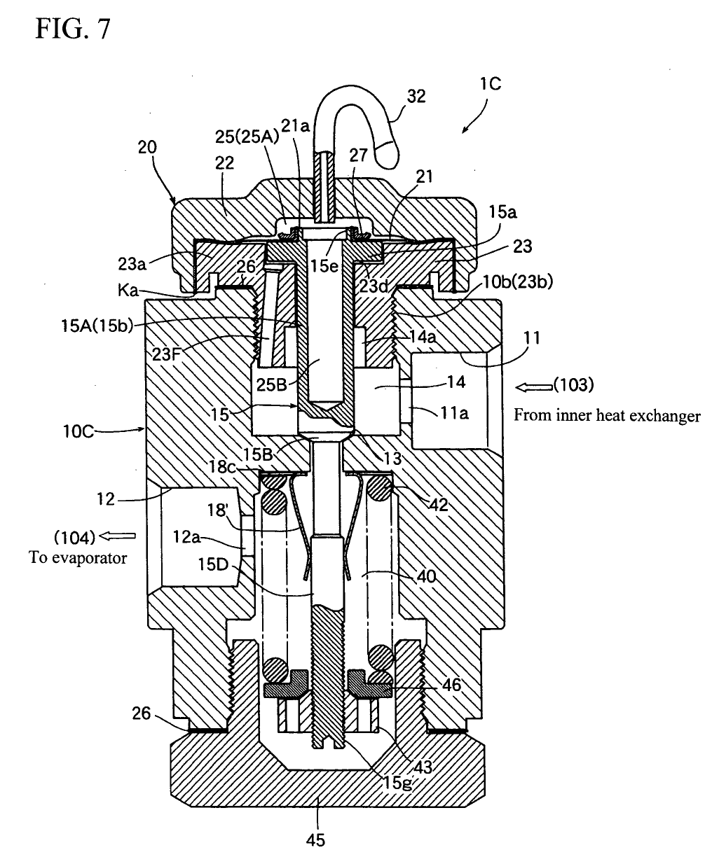

The pressure control valve 1C of a third embodiment shown in FIG. 7 is featured in that a spring chamber 40 is interposed between the refrigerant introduction chamber 14 and the refrigerant outflow port 12 and a compression coil spring 42 is disposed in the spring chamber 40 so as to urge the valve 15 to move in the valve-closing direction. More specifically, the valve 15 is provided, below the valve portion 15B, with an extension shaft 15D having a male thread portion 15g formed thereon, and a vibration-proofing spring 18′ having a similar structure to the vibration-proofing spring 18 of the first embodiment is mounted on this extension shaft 15D. Further, an adjusting nut 43 for adjusting the spring load is screw-engaged with the male thread portion 15g, and the compression coil spring 42 is interposed in a compressed state between the ceiling of spring chamber 40 and a spring shoe 46 mounted on the adjusting nut 43. In this case, the bottom 18c of vibration-proofing spring 18′ is press-contacted with the ceiling of spring chamber 40 by the effect of the compression coil spring 42. By the way, the bottom opening of the ceiling of spring chamber 40 is closed by means of cap member 45 having, for example, a hexagon head and screw-engaged with a lower portion of valve body 10C.

In the case of the pressure control valve 1C constructed in this manner, the opening degree of valve (magnitude of lifting of the valve body 15) is designed to be determined according to the balance between the valve-opening force to be effected by a pressure difference between the inside and the outside of the temperature sensitive chamber and the valve-closing force to be effected by the compression coil spring 42.

By the way, in this embodiment, an annular projection 15e is formed on the top end of the valve 15 (of the temperature sensitive chamber 25B), and a peripheral edge portion of communicating hole 21a of diaphragm 21 which is bent upward is externally inserted on the annular projection 15e. Further, a ring 27 having an L-shaped cross-section is externally press-fitted with the outer circumferential wall of the communicating hole 21a of diaphragm 21. Additionally, this engaged portion among the annular projection 15e, the peripheral edge portion of communicating hole 21a and the ring 27 is bonded to each other by means of welding.

Meanwhile, in order to enhance the temperature sensitivity of the refrigerant that has been introduced into the refrigerant introduction chamber 14 in the in-valve temperature sensitive chamber 25B, an annular enlarged introduction portion 14a is formed all around the in-valve temperature sensitive chamber 25B and, at the same time, a communicating hole 23F is formed outside the in-valve temperature sensitive chamber 25B for communicating the refrigerant introduction chamber 14 with the recessed portion 23d which is provided at a central top portion of the cap-receiving member 23.

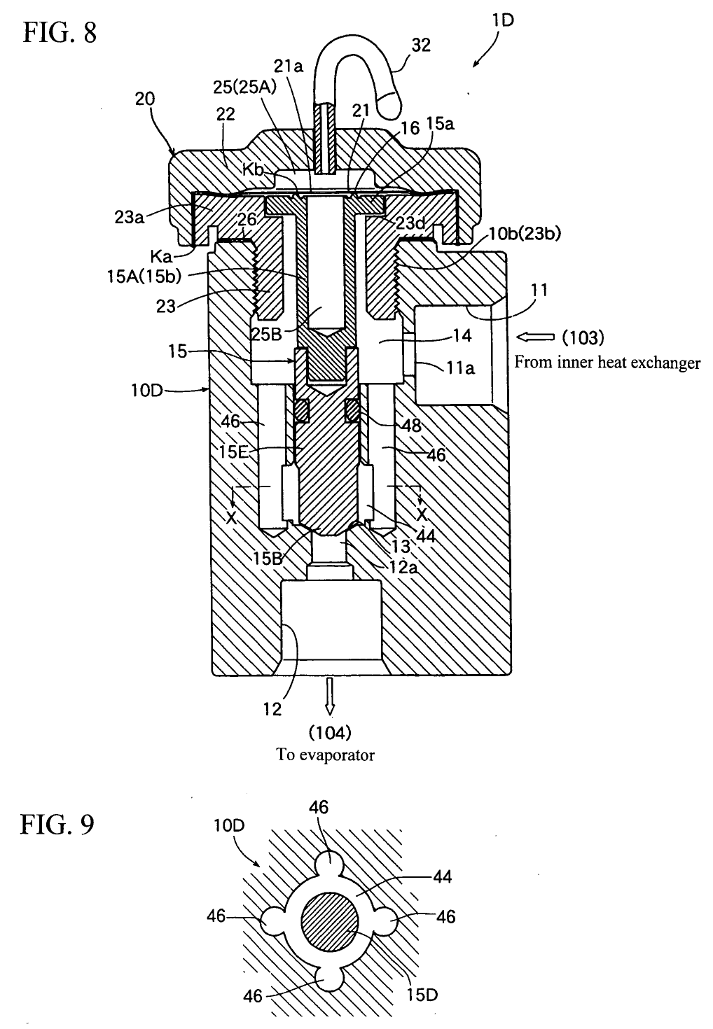

The pressure control valve 1D of a fourth embodiment shown in FIG. 8 is featured in that it is provided with a valve chamber 44 having the valve seat 13 and disposed at a location inside the valve body 10D which is more or less spaced away from the refrigerant introduction chamber 14, wherein the refrigerant introduction chamber 14 is communicated, through a plurality (four for instance) of small communicating holes 46, with the valve chamber 44 (see also FIG. 9).

More specifically, the valve 15 is constituted by a valve stem 15A having in-valve temperature sensitive chamber 25B formed therein, and an extension shaft 15E having a valve portion 15B press-inserted on and coupled with a lower end portion of the valve stem 15A. A valve chamber 44 is formed around a lower portion of this extension shaft 15E and a plurality of communicating holes 46 are provided around the valve chamber 44 at equiangular intervals.

Since the pressure control valve 1D is constructed in this manner, it is possible to minimize any adverse influence (cooling effects) to the temperature sensitive chamber 25 by the refrigerant that has been throttled by the valve seat 13 and decreased in temperature.

By the way, in the case of this pressure control valve 1D according to this embodiment, an O-ring 48 which is provided to seal the interface between the valve 15 (extension shaft 15E) and the valve body 10D is designed to serve as vibration-proofing means for suppressing the trembling of the valve 15.

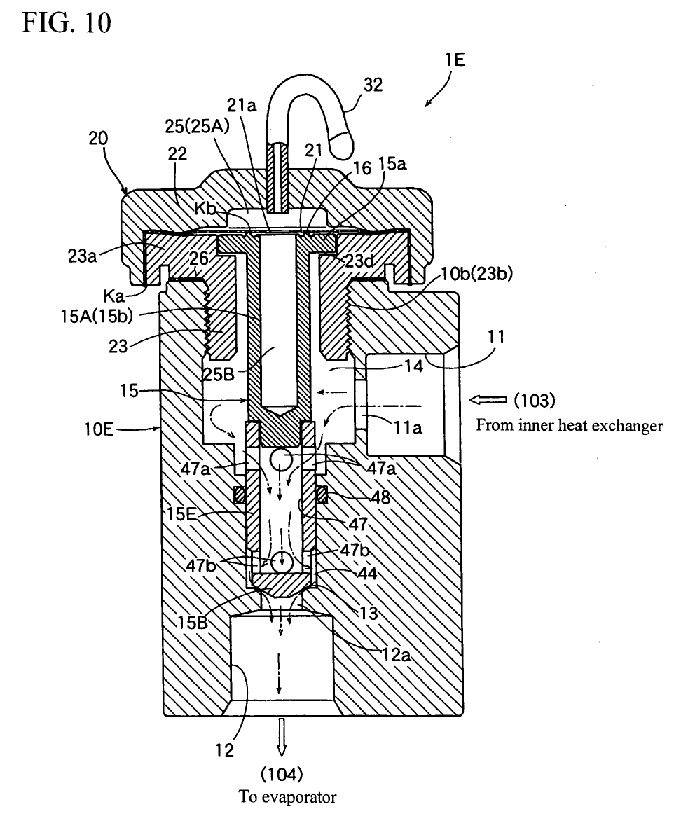

The pressure control valve 1E of a fifth embodiment shown in FIG. 10 is featured in that, as in the case of the fourth embodiment mentioned above, it is provided with a valve chamber 44 having the valve seat 13 and disposed at a location inside the valve body 10E which is more or less spaced away from the refrigerant introduction chamber 14, wherein the refrigerant introduction chamber 14 is communicated, through a communicating hole 47 formed inside the extension shaft 15E, with the valve chamber 44.

More specifically, the valve 15 is constituted by a valve stem 15A having in-valve temperature sensitive chamber 25B formed therein, and an extension shaft 15E having a valve portion 15B press-inserted on and coupled with a lower end portion of the valve stem 15A. A valve chamber 44 is formed around a lower portion of this extension shaft 15E and a communicating hole 47 is formed inside the extension shaft 15E. This communicating hole 47 is provided, at an upper portion thereof, with a plurality (four for instance) of circular openings 47a which are disposed at equiangular intervals and communicated with the refrigerant introduction chamber 14, and also provided, at a lower portion thereof, with a plurality (four for instance) of circular openings 47b which are disposed at equiangular intervals and communicated with the valve chamber 44.

Therefore, as shown by a dashed arrow in FIG. 10, in the case of the pressure control valve 1E of this embodiment, the refrigerant that has been introduced into the refrigerant introduction chamber 14 is delivered, through the communicating hole 47 formed inside the extension shaft 15E, to the valve chamber 44 and then the refrigerant is throttled by the valve seat 13 and delivered from the valve chamber 44 to the refrigerant outflow port 12.

As described above, since the valve chamber 44 is disposed at a lower location which is more or less spaced away from the refrigerant introduction chamber 14 and the refrigerant introduction chamber 14 is communicated with the valve chamber 44 through the communicating hole 47 formed inside the extension shaft 15E, it is possible to minimize any adverse influence (cooling effects) to the temperature sensitive chamber 25 by the refrigerant that has been throttled by the valve seat 13 and decreased in temperature. Furthermore, since the communicating hole 47 is formed close to the valve 15 in this embodiment, the work to manufacture the valve body 10E would be more facilitated as compared with the valve body 10D of the fourth embodiment.

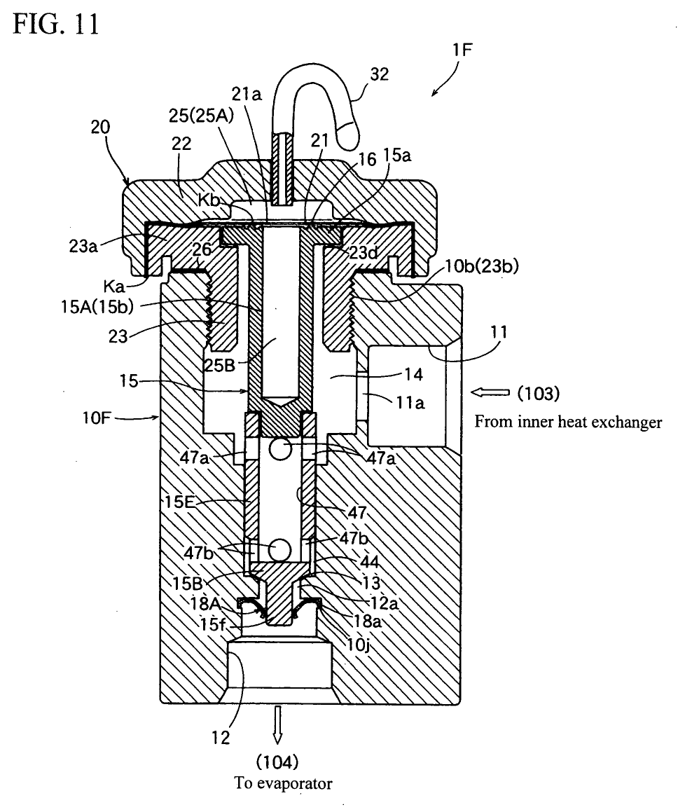

The pressure control valve 1F of a sixth embodiment shown in FIG. 11 is featured in that a vibration-proofing spring 18A is employed in place of the O-ring 48 which is employed as a vibration-proofing means in the pressure control valves 1D and 1E of the fourth and fifth embodiments shown in FIGS. 8 and 10.

Namely, a cylindrical projection 15f is extended from the lower end of the extension shaft 15E of pressure control valve 1E of the fifth embodiment and the vibration-proofing spring 18A which is similar in construction to the vibration-proofing spring 18 of the aforementioned first embodiment is mounted on this cylindrical projection 15f. Further, the externally extending teeth 18a of this vibration-proofing spring 18A are engaged with an annular groove 10j formed in a stepped outlet passageway 12a, thereby suppressing the trembling of the valve 15 by this vibration-proofing spring 18A.

In the cases of the pressure control valves 1D and 1E of the fourth and fifth embodiments, since the O-ring 48 is employed as a vibration-proofing means, there is a possibility of generating a problem that a torsional stress may be generated at the portion of projection welding (the bonding portion between the annular projection 16 and the diaphragm 21) on the occasion of screw-engaging the temperature-sensitive/pressure-responsive element 20 with the valve body 10D or 10E.

Whereas, in the case of the pressure control valve 1F according to this six embodiment, since the vibration-proofing spring 18A can be assembled to the valve 15 and the valve body 10F from a lower portion (refrigerant outflow port 12) of the valve body 10F after the attachment of the temperature-sensitive/pressure-responsive element 20, it is possible to obviate the aforementioned problem.

By the way, in the case of the pressure control valve 1F of this sixth embodiment, the O-ring as employed in the pressure control valves 1D and 1E of the fourth and fifth embodiments is not interposed between the extension shaft 15E and the valve body 10F. Even if the O-ring is not employed, since the vibration-proofing spring 18A is assembled to the cylindrical projection 15f of extension shaft 15E, it is possible, by means of this vibration-proofing spring 18A, to suppress the trembling of valve 15. If an O-ring is attached in this case, a redundant torsional stress may be generated at the portion of projection welding on the occasion of introducing the extension shaft 15E into the valve body 10F.

The pressure control valve 1G of a seventh embodiment shown in FIG. 12 is featured in that the construction of the valve 15 is modified in the pressure control valve 1A of the first embodiment shown in FIG. 1.

Namely, the valve stem 15G of valve 15 is constituted by a shaft portion 15g, and a diametrally enlarged portion 15h having a T-shaped cross-section. This diametrally enlarged portion 15h has an axial portion which is press-inserted into and fixed, by means of welding, etc., to a longitudinal hole formed in an upper end portion of the shaft portion 15g. Further, the upper peripheral portion (disc portion) of the diametrally enlarged portion 15h is floatably inserted into a recessed portion 23d provided at a top central portion of the cap-receiving member 23, thus enabling the diametrally enlarged portion 15h to move up and down. In the same manner as in the case of the first embodiment, this diametrally enlarged portion 15h is provided, at a top central portion thereof, with an annular projection 16 having a trapezoidal cross-section and also with annular grooves 16a and 16b which are disposed on the inner side and the outer side of the annular projection 16, respectively. The diaphragm 21 is bonded to the annular projection 16 by means of projection welding (welded portion Kb) in such a manner that the diaphragm 21 is disposed coaxial with the valve 15.

In this embodiment, although the valve stem 15G is not provided with the in-valve temperature sensitive chamber 25B of the first embodiment, a space over the upper surface of the diametrally enlarged portion 15h, which is encircled by the inner side of the annular projection 16 is employed as a temperature sensitive contact chamber 25C. This temperature sensitive contact chamber 25C is made integral, through the circular communicating hole 21a formed at a central portion of the diaphragm 21, with the diaphragm temperature sensitive chamber 25A.

An outer circumferential wall portion of the shaft portion 15g of valve stem 15G, which is exposed to the refrigerant introduction chamber 14, is provided with a plurality of annular grooves 15i. Due to the provision of a plurality of annular grooves 15i on the outer circumferential wall portion of the shaft portion 15g, the surface area of the shaft portion 15g is increased, thereby enabling the heat from the refrigerant in the refrigerant introduction chamber 14 to be more readily received by the shaft portion 15g, thus making it possible to further enhance the temperature-sensing effects of valve 15.

Further, the valve seat 13 is provided with a plurality (four in this embodiment) of bleed notches 62 which are radially formed at equi-angular intervals (90° in this embodiment) so as to enable the refrigerant that has been introduced into the refrigerant introduction chamber 14 to leak therefrom to the refrigerant outflow port 12 even in a valve-closing state. These bleed notches 62 can be created by subjecting the valve seat 13 to a notch-forming press work. Due to the provision of these bleed notches 62, the working of the outlet passageway 12a can be facilitated and, at the same time, it is possible to derive the self-cleaning effects on the occasion of operating the control valve. By the way, in place of these bleed notches 62, other leakage means such as a through-hole, a groove, a recess, an indent, etc. may be formed in the valve seat 13 and/or the valve body 15B for enabling the refrigerant that has been introduced into the refrigerant introduction chamber 14 to leak therefrom to the refrigerant outflow port 12 even in a valve-closing state. Even in this case, it is possible to derive the aforementioned self-cleaning effects.

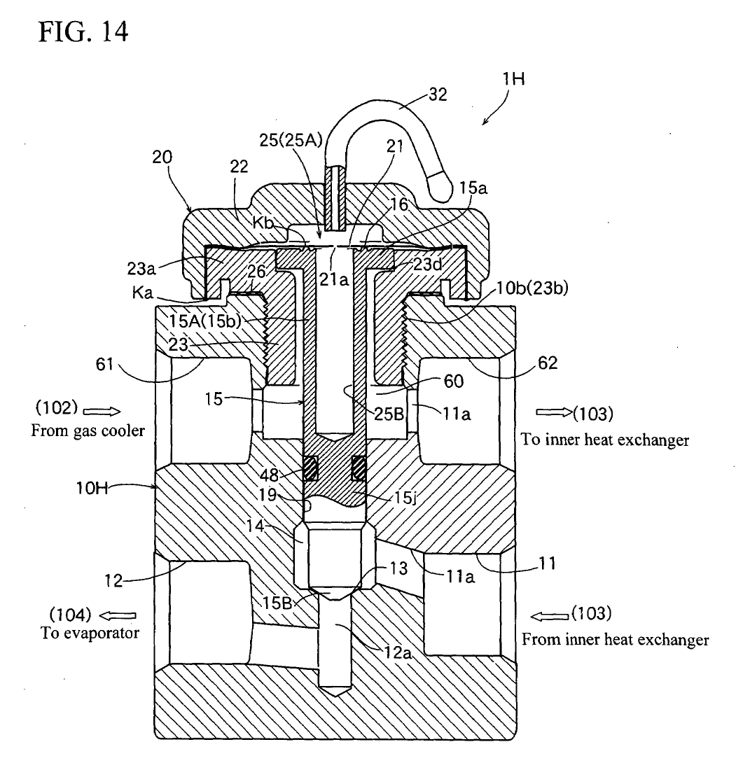

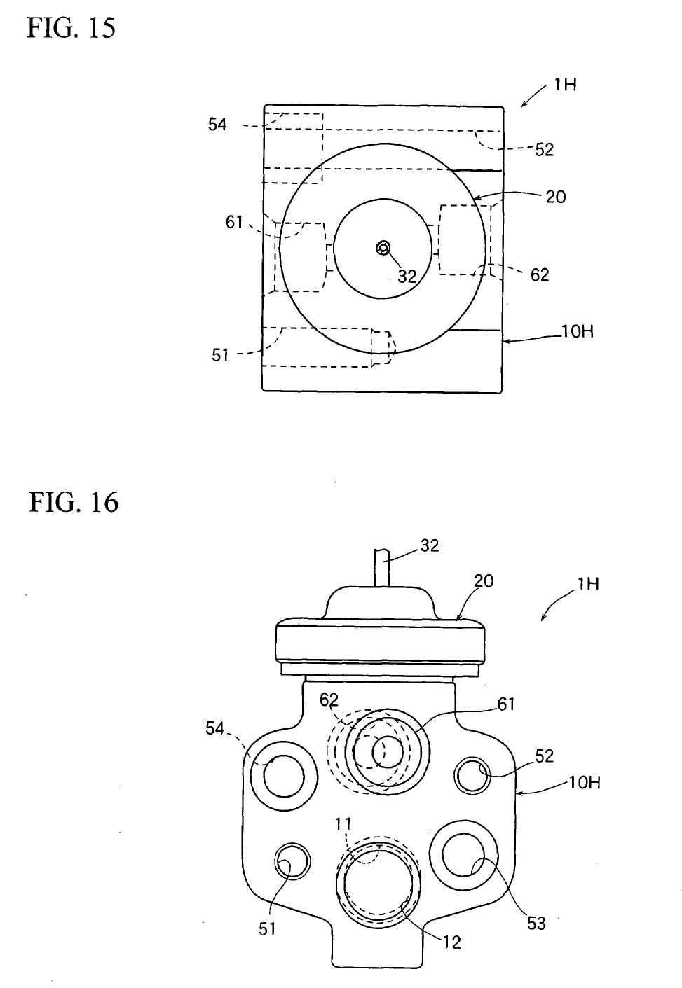

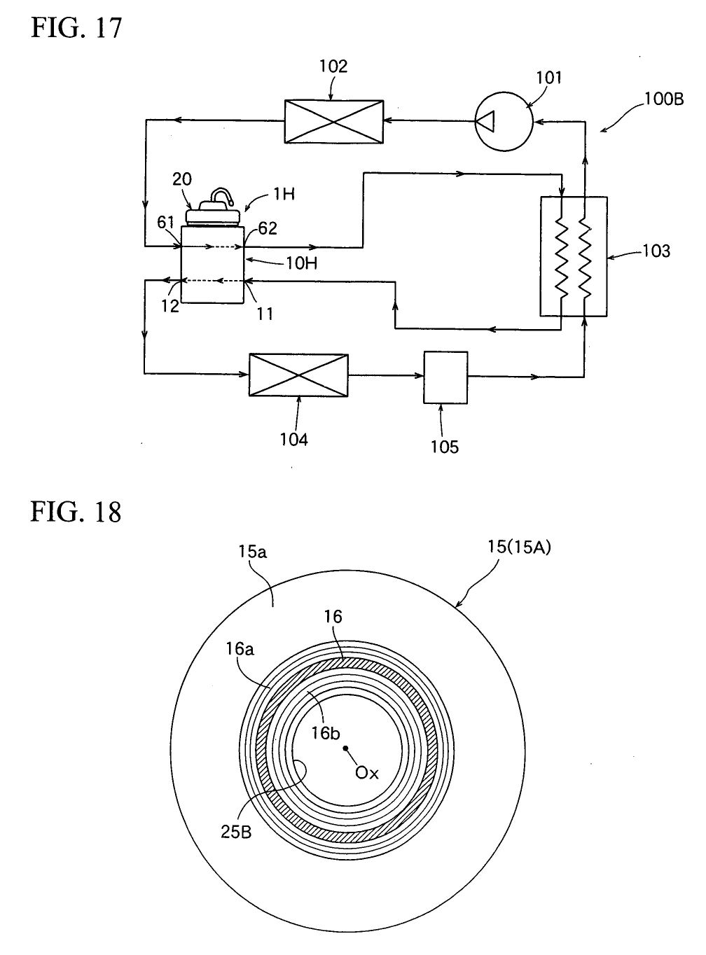

Next, the pressure control valve 1H of an eighth embodiment will be explained with reference to FIGS. 14-18. FIGS. 14, 15 and 16 are a longitudinal cross-sectional view, a plan view and a left side view of the pressure control valve 1H of an eighth embodiment, respectively. As shown in FIG. 17, the pressure control valve 1H shown herein is designed to be built in a vapor compression refrigeration cycle 100B which is constructed in fundamentally the same manner as shown the vapor compression refrigeration cycle shown in FIG. 19, wherein the refrigerant to be introduced into the pressure control valve 1H from the gas cooler 102 through the inner heat exchanger 103 is enabled to be regulated in pressure in conformity with the temperature of refrigerant on the exit side of the gas cooler 102 before the refrigerant is delivered to the evaporator 104. By the way, in the vapor compression refrigeration cycle 100B shown in FIG. 17 as well as in the pressure control valve 1H shown in FIGS. 14-16, the members or parts having the same construction or the same function as those of the refrigeration cycle 100 shown FIG. 19 or as those of the pressure control valve 1A shown in FIGS. 1 and 2 are identified by the same reference symbols, thereby omitting the repeating explanation thereof.

The pressure control valve 1H is provided so as to effectively operate the refrigeration cycle 100B. In other words, this pressure control valve 1H is provided to regulate the pressure of the refrigerant on the exit side of gas cooler 102 so as to obtain a maximum coefficient of performance relative to the temperature of the refrigerant on the exit side of gas cooler 102. Therefore, this pressure control valve 1H comprises a valve body 10H, a valve 15 constituted by a valve stem 15A and a conical valve portion 15B formed at a lower end portion of the valve stem 15A, and a temperature-sensitive/pressure-responsive element 20.

This valve body 10H is formed from a solid material that can be obtained through the cut-out of an aluminum extruded material having a cross-shaped cross-section (FIG. 16), this rectangular parallelepiped body being subsequently subjected to cutting work so as to create various functional portions as described below. Namely, this valve body 10A is provided, at a lower portion thereof, with a pressure-regulating inflow port (coupling portion) 11 which opens to right side and includes an inlet passageway 11a for introducing the refrigerant, via the inner heat exchanger 103, from the gas cooler 102; a valve chamber 14 into which the refrigerant is enabled to introduce from the pressure-regulating inflow port 11; a valve seat 13 having a conically recessed surface constituting the bottom of the refrigerant introduction chamber 14 for enabling the valve 15 (or the valve portion 15B thereof) to be retractably contacted therewith; and a pressure-regulating outflow port (coupling portion) 12 which opens to left side and includes an outlet passageway 12a for delivering the refrigerant from the refrigerant introduction chamber 14 to the evaporator 104.

Further, the valve body 10H is provided, at a central portion thereof, with a guide hole 19 which is communicated with the valve chamber 14 and in which the valve stem 15A (an intermediate portion 15j thereof) of valve 15 is slidably fitted. The valve body 10H is provided, at an upper portion of the guide hole 19 or at an upper portion of the valve body 10H, with a temperature-sensing inflow port 61 which opens to left side for introducing the refrigerant from the gas cooler 102; a temperature-sensing outflow port 62 which opens to right side for delivering the refrigerant to the inner heat exchanger 103; a temperature-sensing refrigerant introduction chamber 60 interposed between the temperature-sensing inflow port 61 and the temperature-sensing outflow port 62. Further, the valve body 10H is provided, at an upper inner circumferential wall thereof, with a female thread portion 10b for attaching a temperature-sensitive/pressure-responsive element 20 (to be explained hereinafter) to this valve body 10H. By the way, an O-ring 48 is mounted on the intermediate portion 15j of valve stem 15 so as to prevent the refrigerant from flowing between the valve chamber 14 and the temperature-sensing refrigerant introduction chamber 60. Further, the temperature-sensing outflow port 62 is off-set back and forth relative to the temperature-sensing inflow port 61.

The temperature-sensitive/pressure-responsive element 20 is constituted by a diaphragm 21 having a short cylindrical configuration with a closed end, by a cap member 22 having a convex cross-section and defining, in cooperation with the diaphragm 21, a temperature-sensitive chamber (diaphragm temperature-sensitive chamber) 25A, and by a cylindrical cap-receiving member 23 with a flange portion 23a for holding and hermetically sealing, in cooperation with the cap member 22, the outer peripheral portion (outer peripheral edge and the cylindrical portion) of the diaphragm 21 and, at the same time, for enabling the valve 15 to be inserted therein. The combined portion (nipped portion) of the cap member 22, the cap-receiving member 23 (the flange portion 23a thereof) and a lower end portion of the sandwiched portion (nipped portion) of the diaphragm 21 are bonded to each other by means of welding-all-around (welded portion Ka).

As in the case of the first embodiment, a top portion of the valve stem 15A of valve 15 is formed into a diametrally enlarged portion 15a which is floatably inserted into a recessed portion 23d provided at a top central portion of the cap-receiving member 23, thus enabling the diametrally enlarged portion 15a to move up and down. As clearly seen from FIG. 4 (cross-sectional view) and FIG. 18 (plan view) both illustrating the aforementioned first embodiment, this diametrally enlarged portion 15a is provided, at a top central portion thereof, with an annular projection 16 having a trapezoidal cross-section and surrounding the top opening of the longitudinal hole (the in-valve temperature sensitive chamber 25B) formed in the valve 15 (which will be explained hereinafter) and also with annular grooves 16a and 16b which are disposed on the inner side and the outer side of the annular projection 16, respectively. The diaphragm 21 is bonded to the annular projection 16 by means of projection welding (welded portion Kb) in such a manner that the diaphragm 21 is disposed coaxial with the valve 15 (a common axial line Ox).

Further, an axial hole (in-valve temperature sensitive chamber 25B) having an open top is provided in the axial portion 15b of the valve 15 (valve stem 15A), and a circular communicating hole 21a for enabling the diaphragm temperature-sensitive chamber 25A to communicate with the in-valve temperature sensitive chamber 25B is formed at a central portion of the diaphragm 21, thereby forming one enlarged temperature sensitive chamber 25 constituted by the diaphragm temperature-sensitive chamber 25A and the in-valve temperature sensitive chamber 25B.

On the other hand, in order to regulate the pressure of the refrigerant on the exit side of gas cooler 102 so as to obtain a maximum coefficient of performance relative to the temperature of the refrigerant on the exit side of gas cooler 102 (for example, if it is admitted that a maximum coefficient of performance can be obtained when the pressure of the refrigerant on the exit side of gas cooler is regulated to 10 MPa as the temperature of the refrigerant on the exit side of gas cooler is 40° C., the pressure control valve is controlled in such a manner that the pressure of the refrigerant on the exit side of gas cooler would become 10 MPa), CO₂ is introduced from a short capillary tube 32 which is attached to the diaphragm temperature sensitive chamber 25A into the enlarged temperature sensitive chamber 25 so as to fill this enlarged temperature sensitive chamber 25 with CO₂ at a predetermined density and, at the same time, this enlarged temperature sensitive chamber 25 is also filled up with an inert gas such as nitrogen gas. Under this condition, a distal end of the capillary tube 32 is sealed.

Further, the cap-receiving member 23 is provided, on the outer peripheral wall of cylindrical portion thereof, with a male thread portion 23b to be screw-engaged with the female thread portion 10b, thereby enabling the cap-receiving member 23 to be attached to the valve body 10A. A unit consisting of the temperature-sensitive/pressure-responsive element 20 (the diaphragm 21, the cap member 22 and the cap-receiving member 23) and the valve 15, which are integrally bonded to each other as described above, is enabled to attach to the valve body 10A by entirely rotating it so as to cause the male thread portion 23b to screw-engage with the female thread portion 10b of the valve body 10A. When the unit is kept attached to the valve body 10H as described above, the temperature-sensing refrigerant introduction chamber 60 is permitted to be created between the cap-receiving member 23 and the top of valve stem 15, thus enabling the temperature of the refrigerant in this temperature-sensing refrigerant introduction chamber 60 to be detected by the temperature sensitive chamber 25.

By the way, a gasket 26 is interposed between the underside of cap-receiving member 23 and the top surface of valve body 10H. Further, tapped holes 51, 52 and circular holes 53, 54 for attaching the control valve 1H to a joint piping coupler for coupling it to the gas cooler 102 or the evaporator 104 or for attaching the control valve 1H to the inner heat exchanger 103 are provided on the right and left sidewalls of valve body 10H.

In the control valve 1H which is constructed in this manner, when the refrigerant on the exit side of gas cooler 102 is introduced from the temperature-sensing inflow port 61 into the temperature-sensing refrigerant introduction chamber 60, the temperature of refrigerant on the exit side of gas cooler 102 is detected by the enlarged temperature sensitive chamber 25. As a result, the inner pressure of this enlarged temperature sensitive chamber 25 is regulated to conform with the temperature of the refrigerant on the exit side of gas cooler 102. In response to the changes of inner pressure of this enlarged temperature sensitive chamber 25, the diaphragm 21 is actuated to drive the valve 15 to move in the valve-closing or valve-opening direction, thus regulating the opening degree of valve, thereby regulating the pressure of the refrigerant on the exit side of gas cooler 102 so as to obtain a maximum coefficient of performance relative to the temperature of the refrigerant on the exit side of gas cooler 102.

As described above, in the case of the pressure control valve 1H, since the opening degree of valve can be regulated by making use of only the temperature-sensitive/pressure-responsive element 20, it is possible to simplify the structure of pressure control valve and to reduce the number of parts as compared with the conventional pressure control valve wherein the opening degree of valve (the magnitude of lifting the valve) is determined based on the balance between the valve-opening force to be effected by a pressure difference between the inside and the outside of the temperature sensitive chamber and the valve-closing force to be effected by the spring member. Additionally, since the temperature-sensitive/pressure-responsive element is enabled to externally mount on the valve body by means of screwing, for example, instead of building it in the valve body, it is now possible to effectively achieve further simplification of the structure of pressure control valve, reduction of the number of parts and reduction of the working and assembling cost.

In addition to these effects, since the valve is provided, at an upper end thereof, with the annular projection 16 to thereby enable the valve to directly bond to the diaphragm 21 by means of projection welding, it is now possible to reduce the number of parts and the number of steps, to simplify the assembling process and, at the same time, to realize a sufficient bonding strength as compared with the cases wherein other bonding methods are employed. Further, even in a case wherein the valve is provided with an axial hole (the in-valve temperature sensitive chamber 25B) having an open top so as to create an enlarged temperature sensitive chamber 25, it is also possible to secure a sufficient air-tightness.

1. A pressure control valve comprising:
a valve body provided successively with, mentioning from the upstream side in the flowing direction of refrigerant, a refrigerant inflow port, a refrigerant introduction chamber, a valve seat with which a rod-like valve is retractably contacted, and a refrigerant outflow port; and
a temperature-sensitive/pressure-responsive element which is provided with a temperature sensitive chamber for sensing the temperature of the refrigerant that has been introduced into the refrigerant introduction chamber and is designed to drive a valve in opening or closing direction in response to fluctuations of the inner pressure of the temperature sensitive chamber;
wherein the temperature-sensitive/pressure-responsive element is integrally attached to the valve body.

2. A pressure control valve which is designed to be built in a vapor compression refrigeration cycle which is constituted by: a compressor for circulating CO₂ as a refrigerant; a gas cooler for cooling the refrigerant that has been compressed by the compressor; an evaporator into which the refrigerant is enabled to enter from the gas cooler; and an inner heat exchanger for performing heat exchange between the refrigerant on the exit side of the evaporator and the refrigerant on the exit side of the gas cooler;
the pressure control valve comprising:
a valve body provided successively with, mentioning from the upstream side in the flowing direction of refrigerant, a refrigerant inflow port, a refrigerant introduction chamber, a valve seat with which a rod-like valve is retractably contacted, and a refrigerant outflow port; and
a temperature-sensitive/pressure-responsive element which is integrally attached to the valve body and provided with a temperature sensitive chamber for sensing the temperature of the refrigerant that has been introduced into the refrigerant introduction chamber and is designed to drive a valve in opening or closing direction in response to fluctuations of the inner pressure of the temperature sensitive chamber;
wherein the refrigerant that has been introduced via the inner heat exchanger into the pressure control valve from the gas cooler is regulated in pressure in conformity with the temperature of the refrigerant before delivering the refrigerant into the evaporator.

3. The pressure control valve according to claim 2, wherein the temperature sensitive chamber is filled with CO₂ at a predetermined density and with an inert gas to fill up the temperature sensitive chamber in order to regulate the pressure of the refrigerant to be introduced into the pressure control valve from the inner heat exchanger to thereby obtain a maximum coefficient of performance relative to the temperature of the refrigerant on the exit side of gas cooler.

4. The pressure control valve according to claim 1, wherein the temperature-sensitive/pressure-responsive element is provided with a diaphragm, a cap member having a convex cross-section and defining, in cooperation with the diaphragm, the temperature-sensitive chamber, and a flanged cylindrical cap-receiving member for hermetically holding, in cooperation with the cap member, an outer peripheral portion of the diaphragm while enabling the valve to be fit inside the flange of the cap-receiving member, wherein the cylindrical portion of the flanged cylindrical cap-receiving member is provided with an external thread to be used in attaching the cap-receiving member to the valve body.

5. The pressure control valve according to claim 4, wherein the valve is disposed coaxial with the diaphragm and an end portion of the valve is bonded to the diaphragm by means of projection welding.

6. The pressure control valve according to claim 4, wherein the valve is constituted by a cylindrical valve stem and a valve portion provided at a lower end portion of the valve stem, and the valve stem is constituted by a shaft portion and a diametrally enlarged portion which is integrally formed with or secured to an upper end portion of the shaft portion, thereby enabling the diaphragm to be bonded to the upper surface of the diametrally enlarged portion.

7. The pressure control valve according to claim 4, wherein the valve is provided with an axial hole having an open top, and the diaphragm is provided with an opening for communicating the temperature sensitive chamber with the axial hole, thereby constituting one enlarged temperature sensitive chamber consisting of the temperature sensitive chamber and the axial hole.

8. The pressure control valve according to claim 1, wherein the valve body is equipped with a vibration-proofing means for suppressing the trembling of the valve.

9. The pressure control valve according to claim 8, wherein the vibration-proofing means is constituted by a vibration-proofing spring formed of a resilient plate and configured to have an annular bottom portion held in place by the valve body, and a plurality of tongue-like flaps rising from the inner periphery of the annular bottom portion and elastically press-contacted with an outer peripheral surface of the valve.

10. The pressure control valve according to claim 8, wherein the vibration-proofing means is constituted either by an O-ring interposed between the valve and the valve body.

11. The pressure control valve according to claim 1, wherein the pressure control valve is provided with a valve chamber having the valve seat and disposed at a location inside the valve body which is more or less spaced away from the refrigerant introduction chamber, wherein the refrigerant introduction chamber is communicated, through one or plural communicating holes formed in the valve body or in the valve, with the valve chamber.

12. The pressure control valve according to claim 1, wherein the refrigerant inflow port and the refrigerant outflow port are disposed parallel to each other.

13. The pressure control valve according to claim 1, wherein the refrigerant inflow port and the refrigerant outflow port are disposed orthogonally to each other.

14. The pressure control valve according to claim 1, wherein a spring for urging the valve to move in a valve-closing direction is disposed in the valve body.

15. The pressure control valve according to claim 1, wherein the valve seat and/or the valve is provided with a leakage means such as a through-hole, a groove or a notch for enabling the refrigerant that has been introduced into the refrigerant introduction chamber to leak therefrom to the refrigerant outflow port even in a condition where the valve is in a valve-closing state.

16. The pressure control valve according to claim 15, wherein a plurality of bleed notches are radially formed in the valve seat.

17. The pressure control valve according to claim 1, wherein a plurality of annular grooves are formed on the outer peripherally surface of the valve stem which is located to face the refrigerant introduction chamber.

18. A refrigeration cycle, wherein the pressure control valve claimed in claim 1 is interposed between an inner heat exchanger and an evaporator.

19. A pressure control valve comprising:
a valve body provided successively with a refrigerant inflow port, a refrigerant outflow port, a refrigerant introduction chamber and a valve seat with which a rod-like valve is retractably contacted; and
a temperature-sensitive/pressure-responsive element which is integrally attached to the valve body and provided with a temperature sensitive chamber for sensing the temperature of the refrigerant that has been introduced into the refrigerant introduction chamber and is designed to drive a valve in opening or closing direction in response to fluctuations of the inner pressure of the temperature sensitive chamber;
wherein the temperature-sensitive/pressure-responsive element is provided with a diaphragm, and a cap member having a convex cross-section and defining, in cooperation with the diaphragm, the temperature-sensitive chamber, wherein the diaphragm is bonded to an upper end portion of the valve body by means of projection welding.

20. The pressure control valve according to claim 19, wherein the valve is provided, at a central portion of the top surface thereof, with an annular projection to be used for the projection welding.

21. The pressure control valve according to claim 19, wherein the valve is constituted by a cylindrical valve stem and a valve portion provided at a lower end portion of the valve stem, and the valve stem is constituted by a shaft portion and a diametrally enlarged portion which is integrally formed with or secured to an upper end portion of the shaft portion, wherein the diametrally enlarged portion is provided, at a central portion of the top surface thereof, with an annular projection having a triangular or trapezoidal cross-section, said annular projection being bonded to the diaphragm by means of projection welding.

22. The pressure control valve according to claim 20, wherein the valve is provided, on an inner peripheral circumference of the annular projection formed on the top surface thereof, with a temperature sensitive contact chamber or axial hole having an open top, and the diaphragm is provided with a communicating hole for communicating the temperature sensitive chamber with the temperature sensitive contact chamber or with the axial hole.
